(19) United States
(12) Patent Application Publication
(10) Pub. No.: US 2005/0004782 A1
(43) Pub. Date: Jan. 6, 2005

(54) CAD BASED AERATION SYSTEM MODELING SOFTWARE

(75) Inventors: Thomas Edward Frankel, Poughkeepsie, NY (US); Todd David Ritter, Poughkeepsie, NY (US); Seoung-il Kang, Poughkeepsie, NY (US)

Correspondence Address: STAMFORD SCIENTIFIC INTERNATIONAL, INC., 4 TUCKER DRIVE, POUGHKEEPSIE, NY, 12603, US

(73) Assignee: SSI AERATION, INC., Poughkeepsie, NY (US)

(21) Appl. No.: 10/711,360

(22) Filed: Sep. 14, 2004

(51) Int. Cl. G06F 17/50; G06G 7/48; C10J 1/08

(52) U.S. Cl. 703/1; 703/7; 703/6

(57) ABSTRACT

The present invention relates generally to modeling of aeration systems. More particularly, the present invention relates to an automated modeling system that acquires data from entries made into a dialog box. The automated modeling system then generates a full CAD drawing denoting the precise locations of aeration system components in both plan and section view, such as diffusers, support stands, expansion joints, manifold pipes, header pipes, etc., and furthermore generates a materials take-off table.

### FIELD OF THE INVENTION

The invention is related to aeration system design software producing a plan view and section view CAD drawing and a materials take-off from a dialog box.

### BACKGROUND OF THE INVENTION

In the waste-water treatment industry it is necessary to provide drawings for technical process reasons and materials take-offs for providing accurate cost estimates. It is customary for the estimator to assign a draftsman for each quotation or active project order to draw the aeration system in a CAD program. The estimator reviews the drawing and determines the total quantity of each item required by the drawing.

One well known method of producing a drawing is computer-aided drafting within commercially available CAD software. Using this method, the draftsman must make judgments about quantity of headers pipes, quantity of support stands per header and spacing between header pipes and between header pipes and the tank walls. The draftsman must also properly locate the air drop pipe so that there is sufficient space between the drop pipe and the tank wall.

Computer-aided drafting within CAD is time consuming. It is especially so when evaluating and comparing different diffuser types as is common during the quotation stage of a project. It is common for a customer to request drawings of a system with 9″ disc diffusers, an alternate system with 12″ disc diffusers, and a third option with tube diffusers. It is also common for a customer to request a variety of diffuser arrays within each diffuser category, to depict more energy-efficient and less energy-efficient systems. Generally speaking, the more diffusers there are in a tank, the more energy efficient the system will be.

An additional problem with the computer-aided CAD drafting method is the likelihood of human error.

### SUMMARY OF THE INVENTION

The present invention provides an automated layout system that acquires data directly from a dialog box outside of the CAD environment. Aeration system drawings with a variety of diffuser types in thousands of arrangements can be effectively created automatically by linking a master database and rule set of selected requirements with a dialog box and CAD program. This method greatly accelerates the aeration system drawing and take-off procedures, and significantly reduces the chance for error.

### BRIEF DESCRIPTION OF THE DRAWINGS

FIG. 1 is the program's login page.

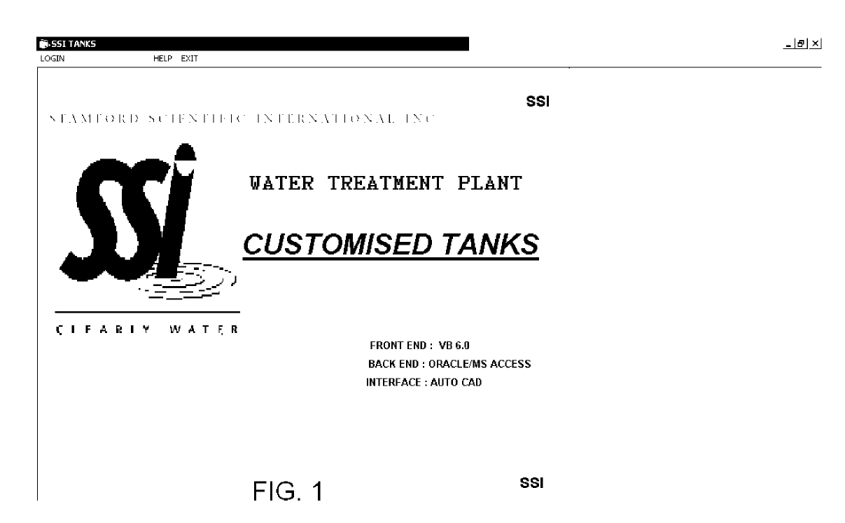

FIG. 2a is the dialog box for Round Tanks into which data relevant to the drawing is entered by an operator (i.e. tank dimensions, diffuser type).

FIG. 2b is the dialog box for Square or Rectangular Tanks into which data relevant to the drawing is entered by an operator.

FIG. 3 is a plan view of a round tank with disc diffusers.

FIG. 4 is a section view of a disc diffuser.

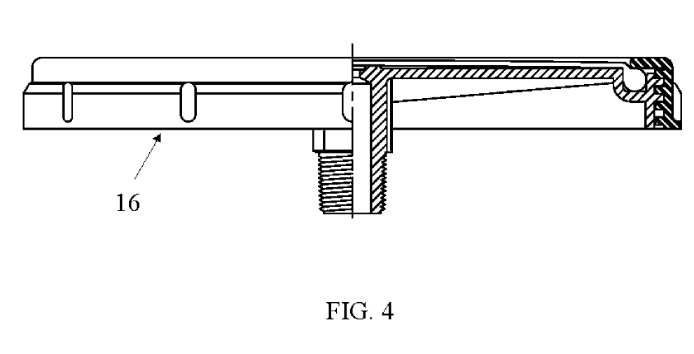

FIG. 5 is a section view of a round tank with disc diffusers.

FIG. 6 is a table restating inputs from the operator into the dialog box.

FIG. 7 is a table showing the materials take-off as calculated by the program.

FIG. 8 is a plan view of a round tank with tube diffusers.

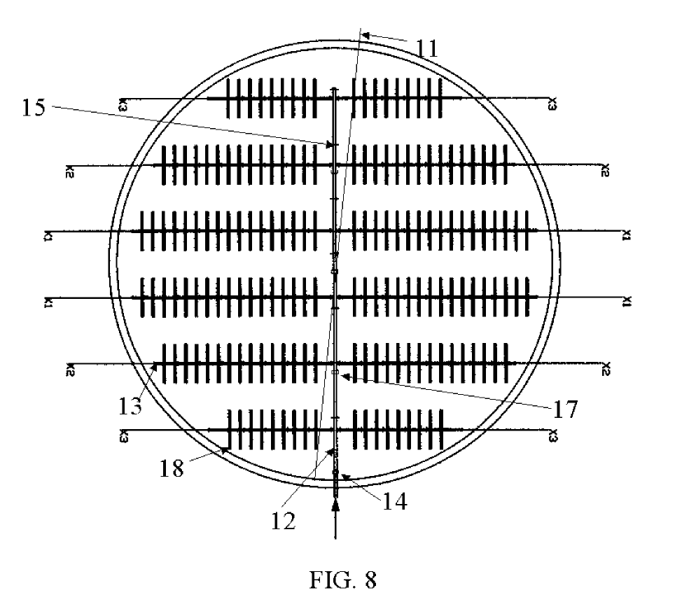

FIG. 9 is a section view of a round tank with tube diffusers.

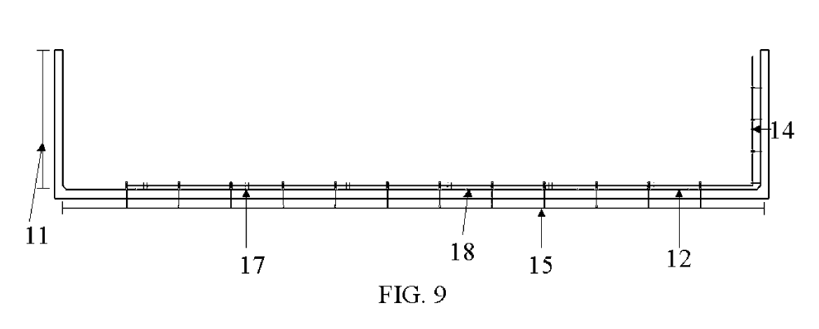

FIG. 10 is a lateral view of a tube diffuser.

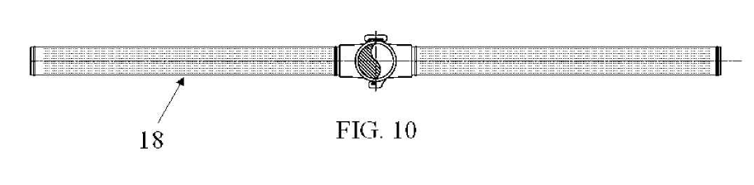

FIG. 11 is a plan view of a rectangular tank with disc diffusers.

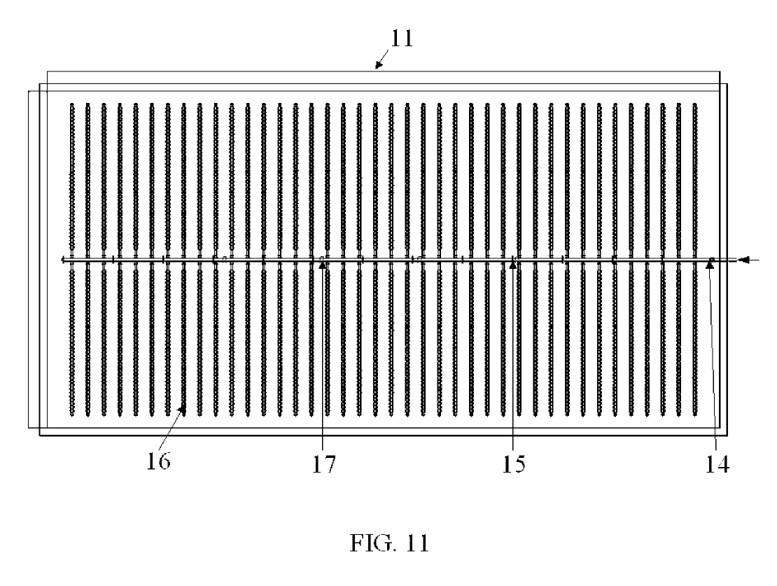

FIG. 12 is a drawing of a support stand.

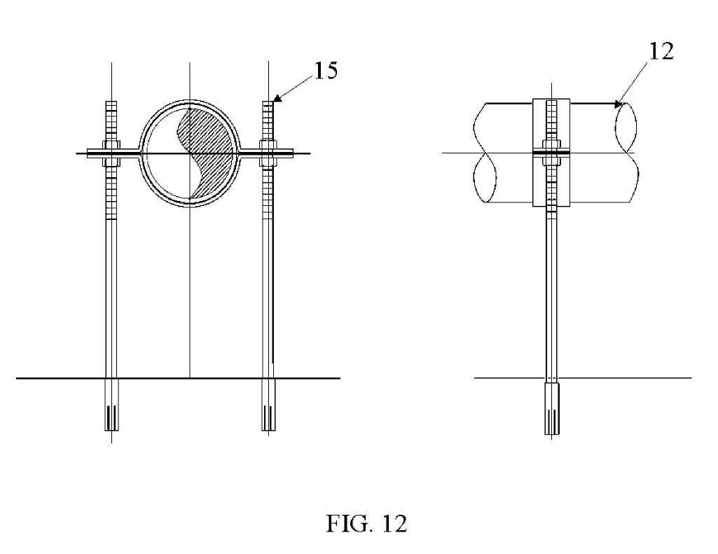

FIG. 13 is a drawing of an expansion joint.

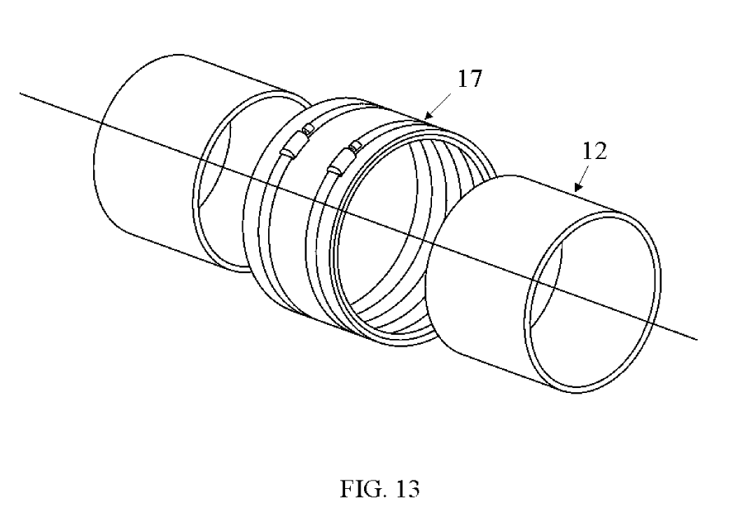

FIG. 14 is a flow diagram showing the programming method.

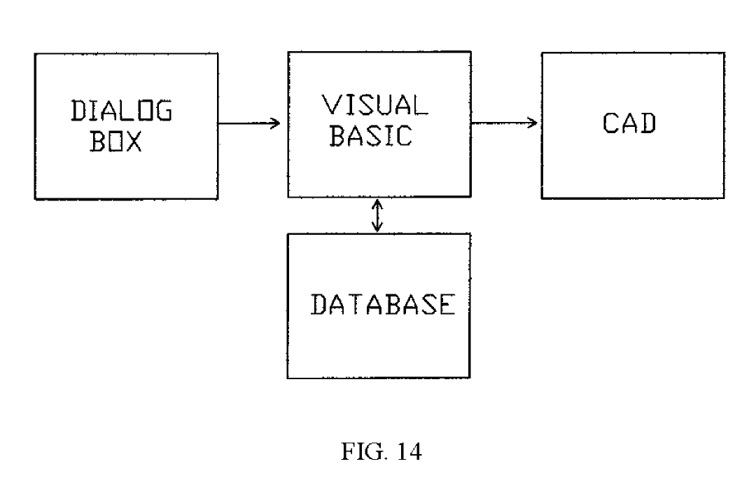

FIG. 15 is a flow diagram showing the method employed by the operator to produce the drawing and materials take-off.

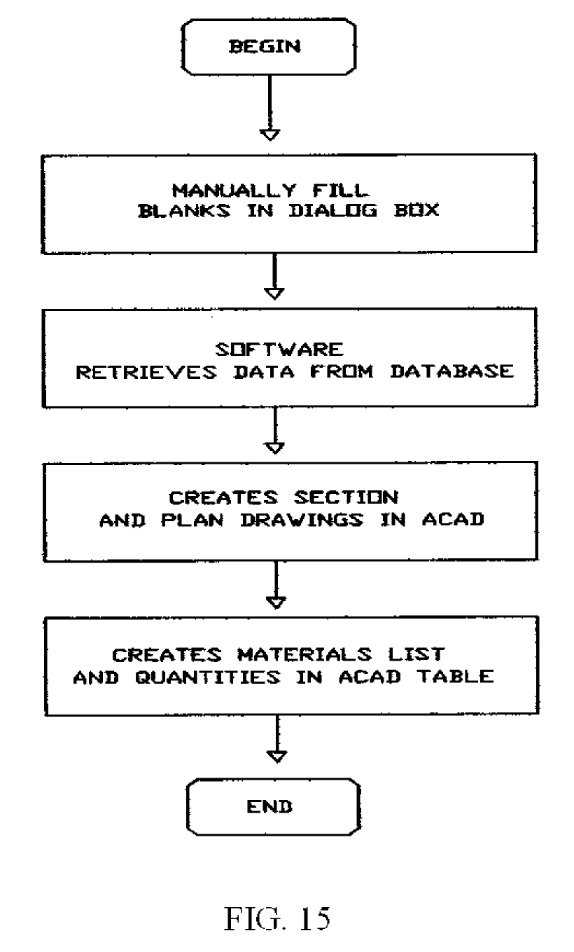

### DETAILED DESCRIPTION OF THE INVENTION

Although certain preferred embodiments of the present invention will be shown and described in detail, it should be understood that various changes and modifications may be made without departing from the scope of the appended claims.

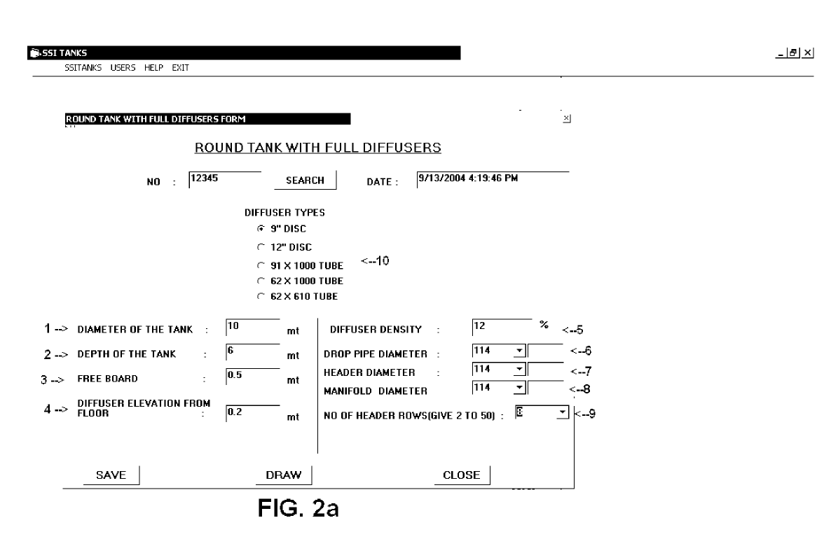

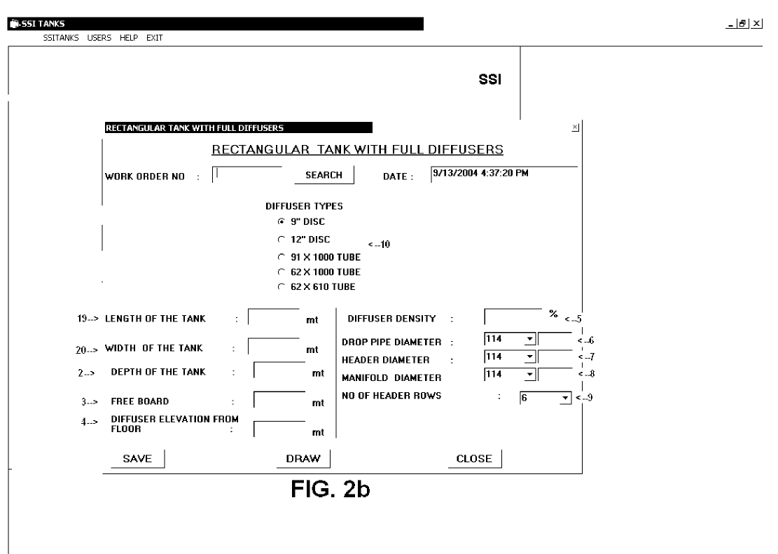

FIG. 2 illustrates a dialog box which has been programmed in Visual Basic to serve as a facilitator between a Database and CAD software. An operator enters inputs into the dialog box such as tank diameter in the case of round tanks 1 or tank length 19 in the case of square or rectangular tanks, tank width in the case of square or rectangular tanks 20, freeboard 3 (height of tank above top water level), diffuser elevation 4 (over the tank floor), header pipe quantity 9, diffuser type 10, and desired diffuser density 5. The operator then clicks the draw button at the bottom of the dialog box, opens the CAD window, and clicks anywhere on the screen. The CAD program then automatically generates the two drawings and two tables.

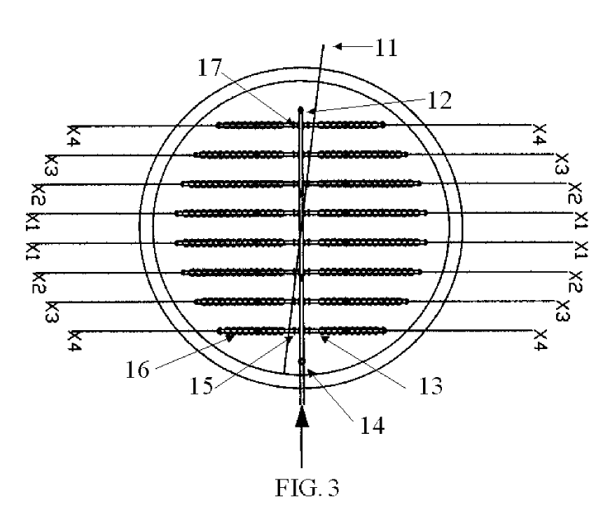

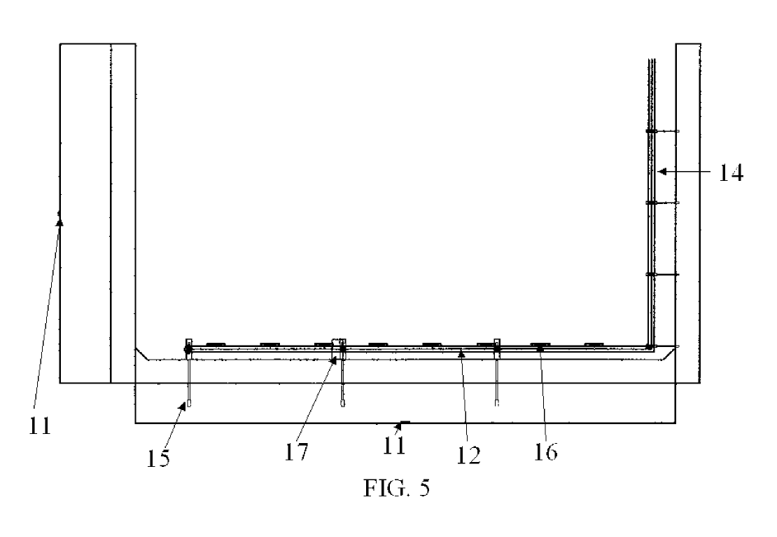

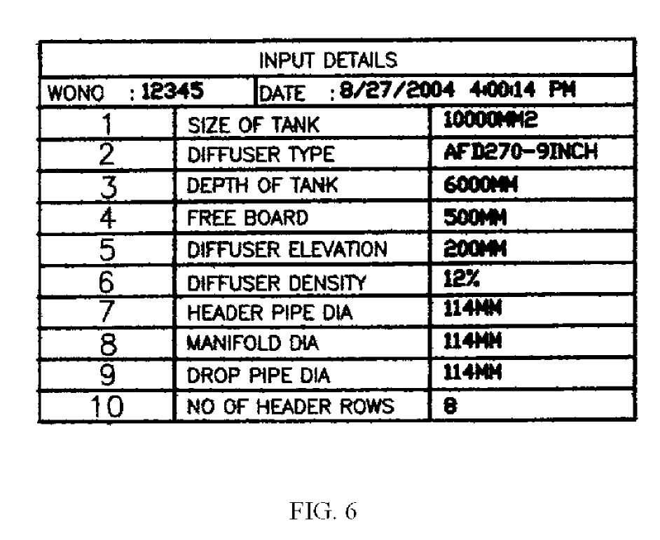

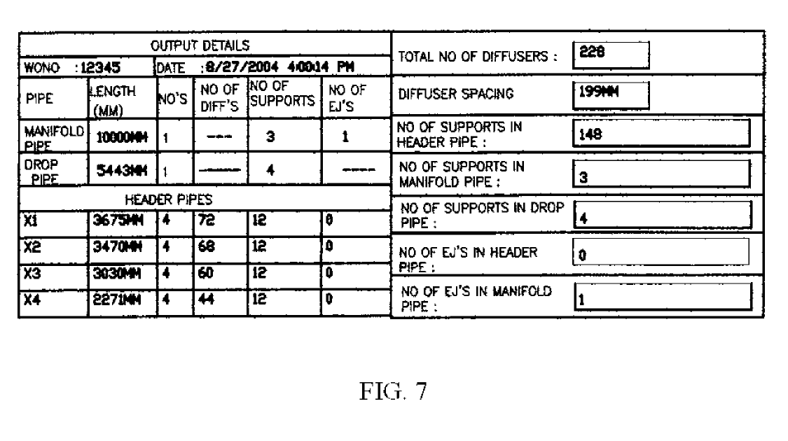

The program considers the active surface area of each disc diffuser 16 or tube diffuser 18, in order to calculate the appropriate diffuser density on the tank floor. It then proceeds to draw the tank dimensions and optimize the required quantity of diffusers on the quantity of header pipes 9 selected by the operator. The method of calculation is particularly novel for round tanks (FIG. 3), where headers are of different lengths. Finally the drop pipe 14, manifold 12, support stands 15 and expansion joints 17 are placed at necessary locations. All pipes are shown as two line drawings to scale in accordance with the pipe sizes entered in the dialog box. Dimensions 11 are shown. The final result within a single CAD page appears with two drawings (plan and section as in FIG. 3 and FIG. 5) and two tables (inputs and take-off output as in FIG. 6 and FIG. 7).

One CAD system suitable for use in the present invention is AUTOCAD 2000 available from Autodesk, Inc. One Database system suitable for use in the present invention is SQL Server from Microsoft Corporation. A variety of computer-aided-drawing (CAD) software programs and database services are available commercially, and no novelty is considered to reside in the particular software programs or computers, printers, input stations and the like selected for the production of the drawings.

It should be understood that a single personal computer may be used to carry out the claimed method.

1. A method for generating drawings for a disc diffuser based aeration system within a round tank and coordinating said drawings with a master database and rule set based on input to a simple dialog box, the method comprising:
a) providing a computer system;
b) generating aeration system drawings and associated data for the aeration system pipe network with the computer system;
c) automatically selecting a typically aerated zone within the tank in which to locate the aeration system;
d) automatically selecting the quantity of aerators per header pipe;
e) automatically determining the spacing of diffusers and accessories such as support stands and expansion joints on the said headers;
f) automatically determining length of headers of varying lengths based on the tank layout;
g) automatically providing a materials take-off in a table thereby selecting raw materials necessary for fabricating the aeration system.

2. The method of claim 1 wherein the aeration system is a tube diffuser based aeration system.

3. The method of claim 1 wherein the aeration systems is a panel diffuser based aeration system.

4. The method of claim 1 wherein the aeration system is placed within a square or rectangular tank.

5. The method of claim 1 wherein the aeration system is placed within a carousel tank.
